(19) United States
(12) Patent Application Publication
(10) Pub. No.: US 2011/0119132 A1
(43) Pub. Date: May 19, 2011

(54) SYSTEM AND METHOD FOR THE CORRELATION OF MOBILE DEVICES WITH MARKERS USED BY A CONTENT DELIVERY SYSTEM IN A RETAIL ENVIRONMENT

(76) Inventors: Timothy B. Morton, Kirkland, WA (US); Timothy Belvin, Woodinville, WA (US)

(21) Appl. No.: 12/621,414

(22) Filed: Nov. 18, 2009

(51) Int. Cl. G06Q 30/00; G08B 1/08; G06Q 50/00; G06Q 10/00

(52) U.S. Cl. 705/14.53; 340/539.13; 705/14.58

(57) ABSTRACT

A system and method for correlating mobile devices with temporary and permanent markers used by an advertising system that delivers content to consumers via a network of display devices. Each mobile device is typically associated with a single consumer, and demographic, financial, merchant, purchase history, or other information about the consumer is maintained by the correlation system. By correlating the mobile device with the marker, the correlation system allows information about the consumer to be shared with the advertising system. The advertising system may use the shared information in order to more accurately target advertising content to the consumer.

### BACKGROUND

An advertising system for the delivery of advertising content to consumers in a retail environment is described in U.S. patent application Ser. No. 12/557,383, filed Sep. 10, 2009, and entitled “SYSTEM AND METHOD FOR THE SERVICE OF ADVERTISING CONTENT TO A CONSUMER BASED ON THE DETECTION OF ZONE EVENTS IN A RETAIL ENVIRONMENT.” The described advertising system divides a retail environment into a number of detection regions, with each detection region monitored by a region manager and containing one or more display devices. Markers, such as radio frequency identification (RFID) tags, RuBee tags, or other tags, are associated with consumers that are visiting the retail environment. Each region manager can detect the location of a marker within the detection region. When the detected location of the marker indicates that the marker is near a display device, the region manager makes a request for delivery of relevant advertising content for presentation to the consumer that is associated with the marker. In response, the advertising system delivers advertising content to the consumer via one or more display devices. Additional details of the advertising system for the delivery of advertising content may be found in the cited application.

Different markers may be utilized by the advertising system to detect the presence of consumers near display devices. Some markers may be temporarily associated with a consumer. For example, a marker may be attached to or embedded in a shopping cart, basket, or bag that is only used by a consumer during a particular visit to the retail environment. Each time the consumer revisits the retail environment, the consumer may be associated with a different marker. In contrast, some markers may be permanently or semi-permanently associated with a consumer. For example, a marker may be embedded in or attached to a card (e.g., a store loyalty card, a credit card, a driver's license, etc.) that is carried by the consumer, or a marker may be attached to or embedded in a mobile phone or other portable device that is carried by the consumer (e.g., in a SIM card that is inserted into a mobile phone or other device). At any point in time, a consumer may therefore be associated with one or more markers.

Because some markers are only temporarily associated with a consumer, a challenge arises in determining the identity of a particular consumer that is associated with a temporary marker at any given time. If the actual identity of a consumer associated with a temporary marker were ascertainable, it would be possible to deliver more accurately targeted advertising to the consumer. Delivery of such advertising content would benefit the advertiser by allowing the advertiser to reach desired consumers, and would benefit the consumer by ensuring that the consumer received actionable information that is personally relevant.

### BRIEF DESCRIPTION OF THE DRAWINGS

FIG. 1 is an overhead view of a retail environment depicting detection regions and correlation zones that are mapped within the environment.

FIG. 2 is block diagram of a correlation system for associating mobile devices used by consumers in a retail establishment with markers used to identify and deliver advertising content for presentation to consumers on display devices in the retail establishment.

FIG. 3A is a perspective view of an in-person location where a consumer can register with the correlation system.

FIG. 3B is an interface of a software application that may be downloaded to a mobile device and used by a consumer to register with the correlation system.

FIG. 4 is a flow diagram of a process implemented by the correlation system to register a mobile device associated with a consumer with a merchant program.

FIG. 5 is a flow diagram of a process implemented by the correlation system to correlate mobile devices used by consumers in a retail establishment with markers used to identify and deliver advertising content for presentation to consumers on display devices in the retail establishment.

FIG. 6 is a representative consumer account record for storing data associated with the consumer, including mobile devices associated with a consumer, markers associated with the mobile devices, merchant programs, and the past purchase history of the consumer.

### DETAILED DESCRIPTION

A system and method for correlating mobile devices with temporary and permanent markers used by an advertising system that delivers content to consumers via a network of display devices is disclosed (hereinafter the “correlation system” or “system”). Each mobile device is typically associated with a single consumer, and demographic, financial, merchant, purchase history, or other information about the consumer is maintained by the correlation system. By correlating the mobile device with the marker, the correlation system allows information about the consumer to be shared with the advertising system. The advertising system may use the shared information in order to more accurately target advertising content to the consumer. The advertising system may also use the shared information to facilitate a purchase by the consumer, such as by enabling a quick check-out using stored account information of the consumer.

The correlation of a mobile device with a marker is performed in a correlation zone that is maintained at the retail environment. When a consumer carrying a mobile device passes through the correlation zone, the correlation system establishes a communication link with the mobile device and reads a universally unique identifier (UUI) that is provided by the mobile device. At the same time, the advertising system detects any markers and reads any marker identifiers (marker IDs) that are simultaneously present in the correlation zone. If only one UUI and one marker ID are identified within the correlation zone, the correlation system associates the marker with the mobile device for the shopping session involving the marker.

In situations where multiple mobile devices and multiple markers are simultaneously detected within a correlation zone, a process for resolving ambiguities between the mobile devices and markers is performed by the correlation system. Multiple correlation zones are maintained at the retail establishment. As consumers circulate through two or more correlation zones with mobile devices and markers, the correlation system narrows the list of possible mobile device and marker pairings until a single pairing remains. When a single paring remains, the correlation system associates the remaining marker with the mobile device for the shopping session involving the marker.

The correlation system maintains a record of the consumer's mobile device and the temporary or permanent marker pairings that are created with the mobile device. In some embodiments, the correlation system allows a consumer to associate two or more merchant programs with the mobile device. For example, a consumer may associate one or more merchant loyalty programs, merchant payment programs (e.g., Amazon Payments, PayPal, etc.), merchant identity programs (e.g., Gmail ID, Live ID, Yahoo! ID, Facebook Name, etc.), or other merchant programs with a particular mobile device. By allowing a consumer to associate multiple merchant programs with the mobile device, the correlation system facilitates the delivery of value-added services to the consumer across multiple merchants.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

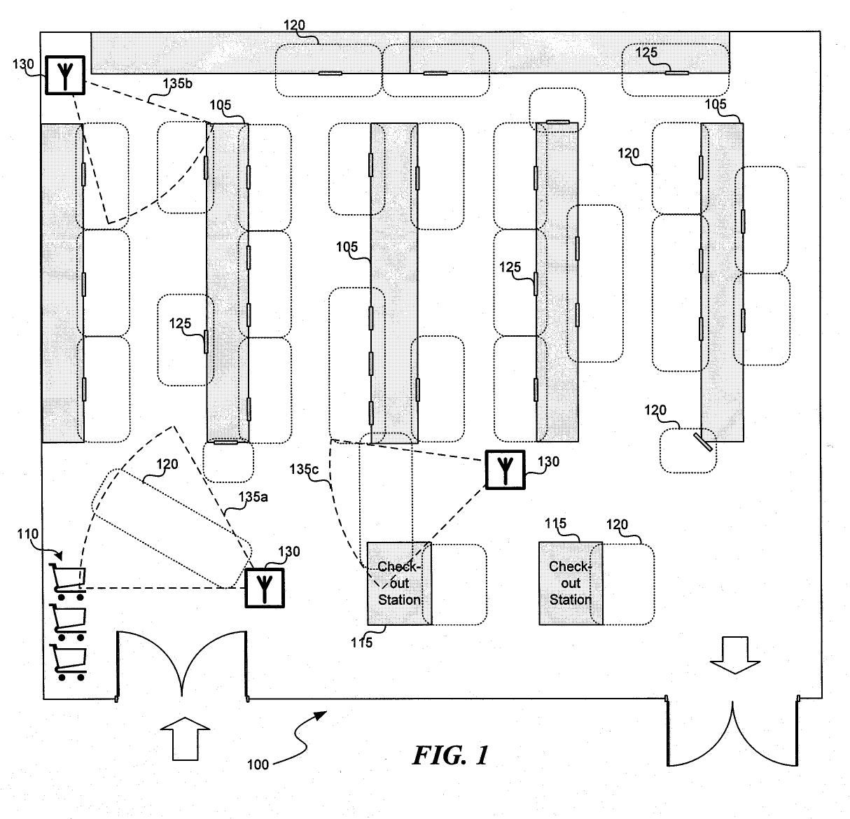

FIG. 1 is an overhead view of a retail environment 100 in which an advertising system for the delivery of targeted advertising content to a consumer based on the detection of zone events is installed. An advertising system for the delivery of advertising content to consumers is described in U.S. patent application Ser. No. 12/557,383, filed Sep. 10, 2009, and entitled “SYSTEM AND METHOD FOR THE SERVICE OF ADVERTISING CONTENT TO A CONSUMER BASED ON THE DETECTION OF ZONE EVENTS IN A RETAIL ENVIRONMENT,” which is hereby incorporated by reference in its entirety. Product shelving 105 and product displays are arrayed throughout the retail environment, forming aisles through which consumers can shop for products. The retail environment contains a pick-up area 110 where a consumer may select a shopping cart, shopping basket, shopping bag, or the like, with which to carry products as they shop within the retail environment. The retail environment also contains one or more check-out stations 115 where the consumer is able to pay for any purchases.

The advertising system delivers targeted advertising content to consumers by tracking the movement of consumers within the retail environment. The retail environment is divided into a number of detection regions 120, with each detection region monitored by a region manager (not shown) and typically containing one or more display devices 125. The detection regions may be equal or different sizes, and may be deployed in a contiguous or non-contiguous fashion. Each display device 125 has an associated display zone in front of the device in which a consumer is likely to be exposed to advertising content that is being presented on the display device. Each display zone is associated with one or more products or categories of products.

The movement of consumers in the retail environment is tracked by the use of markers. A “marker” is any technology component that allows the presence and location of the marker to be detected within a desired accuracy in the retail environment. For example, a marker may be a passive tag, such as a radio frequency identification (RFID) tag that operates in the VHF, UHF or SHF bands. As another example, the marker may be an active tag, such as certain RFID tags or RuBee (IEEE 1902.1) tags that operate in the LF band. Alternatively, the marker may incorporate components that allow the location of the marker to be detected using local wireless network signals or global positioning signals. For example, the location of the marker may be determined by triangulating from local Bluetooth, ZigBee, WiFi, WiMax, cellular or other personal, local, or wide area wireless network signals that are detected by the marker or which can detect the marker. As another example, the marker may incorporate an assisted global position system (A-GPS) receiver so that the marker can compute its location based on received A-GPS signals. On a periodic or aperiodic basis the marker or other wireless network components transmit the marker's location to a region manager.

The marker may be embedded in or attached to a card (e.g., a store loyalty card, a credit card, a driver's license, etc.) that is associated with the retail environment and carried by the consumer, the marker may be embedded in an identification component that is attached to the shopping cart, basket, or bag carried by the consumer, or the consumer may have a marker attached to or embedded in a mobile phone or other portable device that is carried by the consumer (e.g., in a SIM card that is inserted into a mobile phone or other device). The marker may be permanently affixed or embedded within the card (e.g., in a store loyalty card), carrying apparatus or device, or the marker may be temporarily affixed (e.g., by the use of a sticker or other semi-permanent means to affix a marker to a credit card, driver's license, or mobile device). The marker may be permanently associated with the consumer, such as a marker on a driver's license, store loyalty card, or phone that is carried by the consumer during multiple visits. Alternatively, the marker may be temporarily associated with the consumer, such as with a shopping cart, basket, or bag that is used by the consumer only during a particular visit to the retail environment. The retail environment may be any environment in which consumers purchase products, such as a grocery store, a drug store, a clothing store, an office supply store, a hardware store, an auto parts store, etc.

Each region manager can detect when a marker enters a detection region 120 and when a marker leaves a detection region 120. Moreover, the region manager can detect the location of the marker within the detection region. When the detected location of the marker indicates that the marker has entered a display zone, the region manager makes a request to a session manager to deliver relevant advertisements for presentation to the consumer that is associated with the marker. The session manager responds with a response that delivers advertising content to the display device that is contained in the entered display zone. Advertising content may be text, images, or video, or any combination thereof, and may or may not include associated audio. The delivered advertising content is targeted to the consumer based on the particular products or categories of products contained in the zone. The delivered advertising content may also be targeted to the consumer based on known information about the consumer, such as past purchases or shopping behavior observed during the present or prior shopping sessions. The consumer is thereby presented with a very timely and targeted advertising message at the exact time when the consumer is making a purchase decision at the retail establishment. Since the advertising content is delivered to the consumer at the time that the consumer is making a purchase decision, the effectiveness of the advertising content will typically be significantly better than advertising delivered in other channels to the consumer. Additional details about the advertising system may be found in U.S. patent application Ser. No. 12/557,383, previously cited herein.

Operating in conjunction with the advertising system in the retail establishment 100 is a correlation system that allows the markers relied upon by the advertising system to be correlated with mobile devices carried by consumers. Three correlation zone managers 130 are depicted in the retail establishment. Each correlation zone manager 130 is capable of communicating with one or more mobile devices that enter into a correlation zone 135 (labeled 135a-135c) that is monitored by the correlation zone manager. By design, the correlation zones 135 are deployed within the retail establishment so that each correlation zone overlaps with one or more detection regions 120 that are generated by the advertising system. The correlation zones are intended to overlap with the detection regions so that the correlation system is able to assess the simultaneous presence of markers (as detected by the advertising system) and mobile devices (as detected by the correlation zone managers) at the same location in the retail establishment. The simultaneous detection of both markers and mobile devices allows the correlation system to associate a marker with a mobile device in the retail establishment. If only a single mobile device and a single marker are identified within the correlation zone, the correlation system associates the marker with the mobile device for the shopping session involving the marker. If, however, multiple mobile devices and multiple markers are detected within the correlation zone, the correlation system implements a process for resolving the correlation ambiguity as will be described in additional detail herein.

When locating the correlation zones 135 within the retail establishment, two additional considerations may be taken into consideration. The correlation zones are preferably located so that two zones do not overlap with one another. Moreover, the correlation zones 135 are also deployed so that the correlation zones are positioned in locations of anticipated high consumer traffic within the retail establishment. In the retail establishment layout depicted in FIG. 1, for example, the initial correlation zone 135a is located adjacent to an entry point of the retail establishment and to the pick-up area 110 where a consumer is able to select a shopping cart, basket, bag, or other shopping aid. Most consumers who entire the retail establishment would select, for example, a shopping cart before passing through the correlation zone 135a to begin their shopping. The second correlation zone 135b is located at the end of the first aisle that a consumer would likely pass through. And the third correlation zone 135c is located adjacent to the check-out station 115 to detect those consumers that are walking along the aisles to identify a desired aisle to enter. By locating the correlation zones 135 at areas of high traffic, the correlation system is more likely to detect consumers at they circulate throughout the store and thereby be in a position to resolve any ambiguities in mobile device/marker pairings. While three correlation zones are depicted in FIG. 1, it will be appreciated that a greater or lesser number of zones may be deployed in the retail establishment. The number and size of correlation zones that are deployed is dependent on the volume of traffic that is expected through the retail establishment and the anticipated traffic flow patterns through the establishment.

It will be appreciated that although the region manager and the correlation zone managers are depicted as being separate components, the functionality of the region and correlation zone managers may be combined into a single component. The single component merely needs to be capable of receiving UUIs and marker IDs from mobile devices and markers within a common area in the retail establishment.

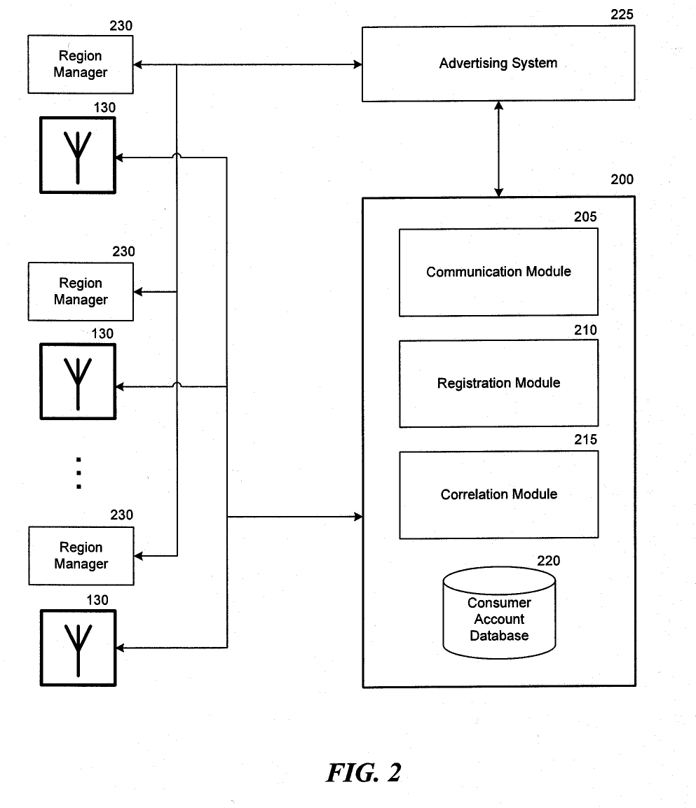

FIG. 2 is a block diagram of a correlation system 200 for associating mobile devices used by consumers in a retail establishment with markers used to identify and deliver advertising content for presentation to consumers on display devices in a retail establishment. The correlation system 200 comprises a communication module 205, a registration module 210, and a correlation module 215. In addition, the correlation system 200 contains a consumer account database 220. The consumer account database 220 maintains data that is operated upon by the modules of the system. The function of each module in the system will be discussed in turn herein.

The communication module 205 allows the correlation system to communicate with mobile devices that are present in the retail establishment. The communication module 205 is connected to one or more correlation zone managers 130 which are deployed throughout the retail establishment. Because of the frequency band at which they operate, the correlation zone managers 130 have a limited area in which they can send and receive signals with mobile devices. Technologies that may be used to communicate with mobile devices include, for example, WiFi, Bluetooth, and similar technologies. As will be appreciated from the discussion of FIG. 1, one or more correlation zone managers 130 are deployed within the retail establishment. A correlation zone manager 130 communicates with a mobile device within its correlation zone in order to obtain a universally unique identifier (UUI) that is transmitted from the mobile device. The UUI may be automatically transmitted from the mobile device so that the correlation zone manager 130 merely detects the UUI transmitted from the mobile device. Alternatively, a request-response procedure may be implemented by the correlation zone manager 130 to query a mobile device and receive the mobile device's UUI in return. Further details about the detection of a UUI from a mobile device may be found in the 3GPP specifications, for example in the ETSI TS 131 102 V8.7.0 (2009-10) technical specification (the “ETSI technical specification”), which is hereby incorporated by reference in its entirety, as well as in other specifications maintained by the 3GPP Organizational Partners and found at 3GPP.org. Section 4.2 of ETSI technical specification sets forth, for example, a description of an Elementary File (EF_{IMSI}) that may be exchanged which contains an International Mobile Subscriber Identity (IMSI) of a mobile device. The IMSI of a mobile device may be utilized as the UUI. Other identifiers that may be used as a UUI include, for example, ESNs (Electronic Serial Numbers), IMEIs (International Mobile Equipment Identifiers), or MEIDs (Mobile Equipment Identifiers) that are associated with mobile devices. A commercially-available receiver that is suitable for use as a correlation zone manager for the detection of mobile device UUIs may be obtained from Rohde & Schwarz International, of Munich, Germany. Once a correlation zone manager 130 receives a UUI from a mobile device, the UUI is transmitted from the correlation zone manager to the communication module 205. The communication module provides the UUI to the correlation module 215 for further processing as described herein.

The communication module 205 also allows the correlation system to communicate with an advertising system 225 that is deployed within the retail establishment or with other back-end systems that are used in the retail environment (e.g., payment processing systems, inventory systems, etc.). When the communication module 205 receives a UUI from a correlation zone manager 130, the communication module queries the advertising system 225 with a request for an indication of all markers that are in the one or more detection regions 120 that overlap with the correlation zone 135 from which the UUI was received. The advertising system 225 receives one or more marker identifiers (marker IDs) from a region manager 230 that monitors a detection region that is coincident with the correlation zone. Once advertising system 225 receives one or more marker IDs from markers that are detected in the coincident detection region, the marker IDs are transmitted from the advertising system to the communication module 205. The communication module provides the marker IDS to the correlation module 215 for further processing as described herein.

The registration module 210 allows a consumer having a mobile device to register with the correlation system 200. The registration module 210 receives information from the consumer, such as contact information, demographic information, financial information, and information about the mobile device of the consumer. The registration module 210 also allows the consumer to register for one or more merchant programs. For example, certain grocery stores have loyalty programs that reward a consumer for the purchase of products at that store. The registration module may therefore allow the consumer to register for participation in the grocery store's loyalty program.

The correlation module 215 is responsible for associating the UUI from a consumer's mobile device with a marker ID from a marker that the consumer is associated with as they shop at a retail establishment. The correlation module 215 allows an association to be drawn between the UUI and the marker ID when the UUI and the marker ID can be linked in an unambiguous fashion. For example, the correlation module 215 associates a UUI with a marker ID when only a single UUI and a single marker ID are detected in the same correlation zone. In contrast, if multiple UUIs and marker IDs are detected in a correlation zone, the correlation module stores a record of possible associations between UUI and marker IDs, and uses the stored record to narrow the list of possible associations during subsequent detections in the same or different correlation zones. In most circumstances, with each subsequent detection the correlation module 215 is able to narrow the list of potential associations until only a single association is unambiguously identified.

The registration module 210 and correlation module 215 are each coupled to the consumer account database 220. The registration and correlation modules store and retrieve data from the consumer account database as necessary to implement the described functionality herein. Those skilled in the art will appreciate that the actual implementation of the consumer account database may take a variety of forms, and the phrase “database” is used herein in the generic sense to refer to any area that allows data to be stored in a structured and accessible fashion using such applications or constructs as databases, tables, linked lists, arrays, and so on.

Those skilled in the art will appreciate that the correlation system 200 may be implemented on any computing system or device. Suitable computing systems or devices include personal computers, server computers, multiprocessor systems, microprocessor-based systems, network devices, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed across multiple computing systems or devices as desired in various embodiments.

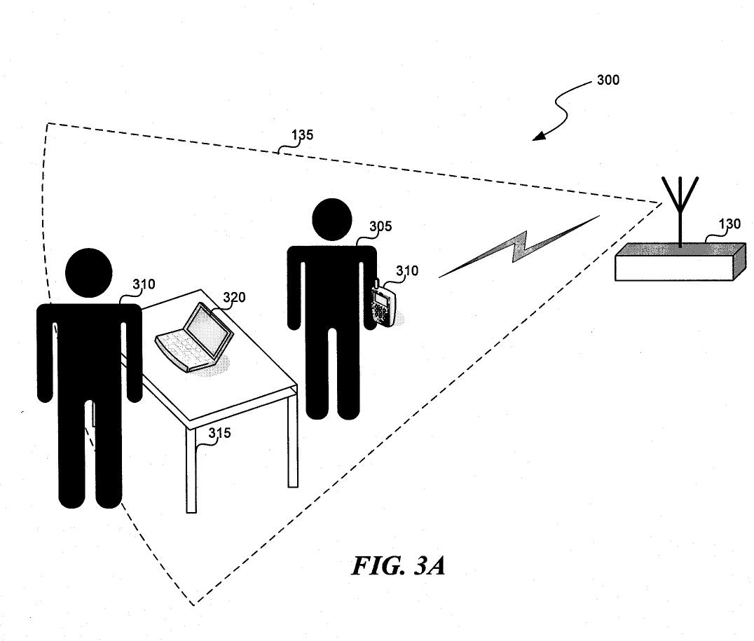

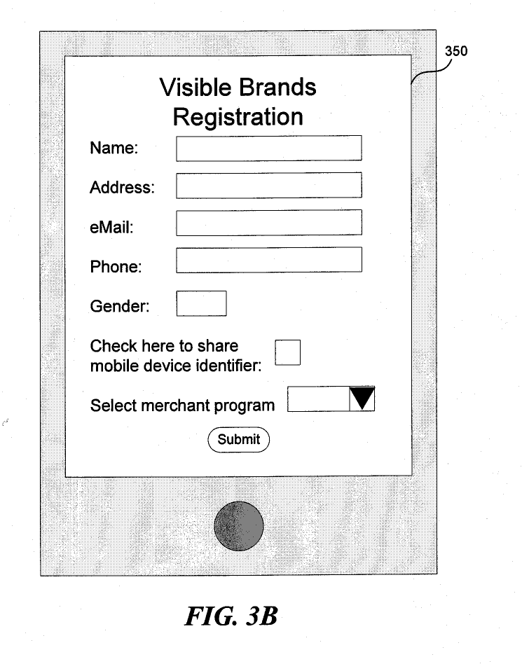

FIG. 3A is a perspective view of an in-person location 300 where a consumer 305 can register with the correlation system 200. Such a registration location may be implemented on a temporary or permanent basis at, for example, a retail establishment. As depicted in FIG. 3, the consumer 305 carries a mobile device 310. The mobile device 310 may be a smart phone (e.g., an iPhone®), a personal digital assistant (PDA), an e-mail device (e.g., a Blackberry®), a portable gaming device (e.g., a GameBoy®), a portable media player (e.g., an iPod®), or any other portable device having communication capability and transmitting a universally unique identifier (UUI). While only a single mobile device is depicted in FIG. 3, it will be appreciated that a consumer 305 may have two or more mobile devices that they typically carry on their person. If a consumer carries two or more mobile devices, the registration module 210 allows the consumer to register all mobile devices as being associated with the consumer.

A representative 310, such as an employee of a merchant or the correlation system operator, is located behind a registration table 315. The representative registering the consumer is able to access the registration module 210 using a laptop computer 320 or other computer terminal. During the registration process, information about the consumer is collected, such as the consumer's name, address, contact information (e.g., phone, email, SMS address), and financial information (e.g., credit cards, debit cards). The consumer is also able to identity one or more merchant programs in which the consumer already participates or would like to participate. To identify a merchant program, the consumer may be asked to provide both the unique program number that identifies the consumer, as well as any passwords or other codes required to access features of the merchant program. While registering with the correlation system, the consumer 305 is within correlation zone 135 defined by the correlation zone manager 130. The correlation zone manager 130 is capable of transmitting and receiving signals with the consumer's mobile device 310. During the registration process, the correlation zone manager 130 communicates with the consumer's mobile device 310 in order to obtain the UUI associated with the device. The information received from the consumer and the UUI received from the device are stored in a consumer account that is created for the consumer.

FIG. 3B is an interface 350 of a software application that may be downloaded to a mobile device and used by a consumer to register with the correlation system 200. The interface allows a consumer to provide information, such as the consumer's name, address, demographic information, contact information, financial information, and identity of merchant programs (including any passwords) in which the consumer participates in or would like to participate. The information entered by the consumer in the software application is automatically transmitted from the mobile device to the registration module 210 of the correlation system 200. In addition, when authorized by the consumer, the mobile device transmits the UUI associated with the device directly to the registration module. The consumer information and the UUI may be encrypted or otherwise transmitted to the correlation system in a secure fashion in order to protect the privacy of the consumer.

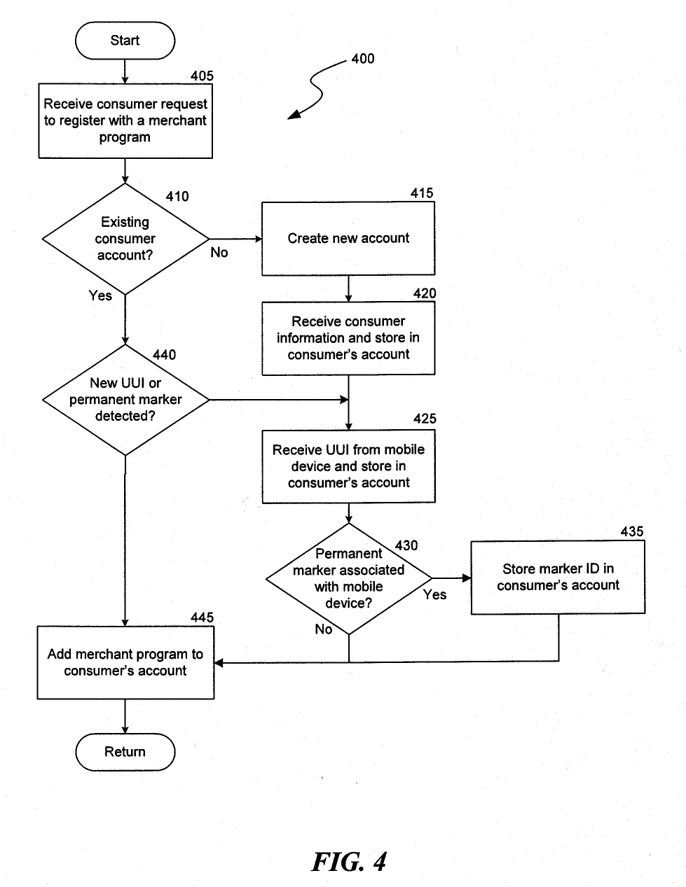

FIG. 4 is a flow diagram of a process 400 that is implemented by the registration module 210 to register a mobile device associated with a consumer and record consumer and mobile device information in a consumer's account. At a block 405, the registration module receives a consumer request to add a merchant program to a new or existing account. The request could be received, for example, at the physical location of the merchant (such as depicted in FIG. 3A), or it may be received via a software interface (such as depicted in FIG. 3B).

At a decision block 410, the registration module 210 determines whether the consumer already has an account with the correlation system. If the consumer does not have an existing account, at a block 415 the registration module creates a new account for the consumer. At a block 420, the registration module receives consumer information and stores the information in the consumer's account. As previously described, the consumer information may include the consumer's name, address, contact information, demographic information, financial information, etc. At a block 425, the registration module receives and stores a UUI that is associated with the consumer's mobile device in the consumer's account. As was described with respect to FIG. 3A, the UUI may be detected by the correlation zone manager. Alternatively, as was described with respect to FIG. 3B, the UUI may be detected by an application that is installed on the consumer's mobile device.

At a decision block 430, the registration module determines whether there is a marker that is permanently or semi-permanently associated with the consumer's mobile device. A permanent or semi-permanent marker may be, for example, a radio frequency identification tag that is embedded in or otherwise permanently affixed to the consumer's mobile device. If a marker is permanently or semi-permanently associated with the consumer's mobile device, processing continues to a block 435. At block 435, the registration module stores the marker ID in the consumer's account. If no permanent or semi-permanent marker is associated with the mobile device at decision block 430, processing continues to a block 445.

At block 445, the registration module adds the merchant program to the consumer's account. That is, the registration module stores an identifier that is provided by the merchant and which identifies the consumer to the merchant. The identifier may be a unique alpha-, numeric-, or alpha-numeric code that is generated by the merchant. The registration module may also store a textual description or other code to identify the merchant program (e.g., “Best Buy@ loyalty program,” “Kroger@ loyalty program”). The registration process for consumers that did not previously have an account with the correlation system is then complete.

Blocks 415 through 435 are only executed once for each new consumer that registers with the correlation system. If at decision block 415 a consumer already has an account with the correlation system, processing continues to a block 440. At block 440, the registration module determines whether a new UUI or permanent marker is detected for the consumer. A new UUI or permanent marker is detected, for example, if a consumer that already has an account with the correlation system acquires a new mobile device. If a new UUI or permanent marker is detected for the consumer, at blocks 425-435 the registration module adds the new UUI or marker ID information to the consumer's account. If a new UUI or permanent marker is not detected, processing continues to block 445. At block 445, the registration module adds the merchant program to the existing account of the consumer. Adding a new merchant program to the existing consumer's account comprises adding a unique identifier that the merchant uses to identify the consumer.

While only a single UUI and marker ID for a consumer are contemplated in the flow chart of FIG. 4, it will be appreciated that the registration module could also store multiple UUIs or permanent marker IDs in a consumer account. For example, if a consumer owns and carries multiple mobile devices (e.g., a smart phone and a media player), the consumer may register both mobile devices with the correlation system. Similarly, if multiple permanent markers are associated with the consumer, such as a marker in a SIM card of a smart phone and an RFID marker applied to a portable gaming device, both marker IDs may be stored in the consumer account.

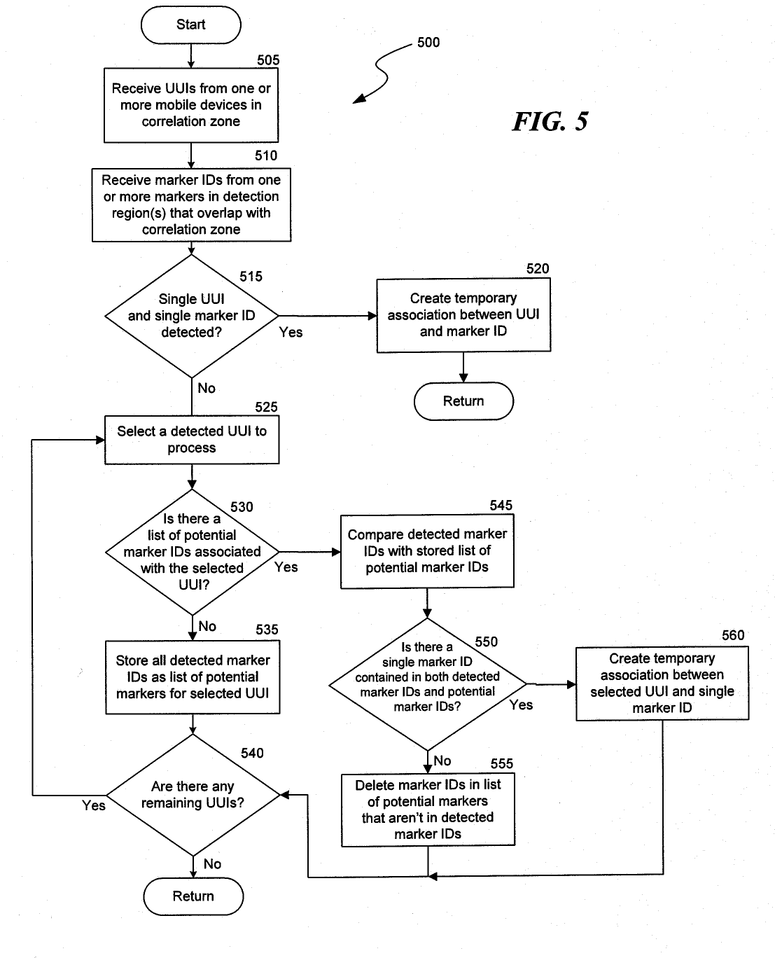

FIG. 5 is a flow diagram of a process 500 implemented by the correlation module 215 to associate mobile devices used by consumers in a retail establishment with markers used to identify and deliver advertising content for presentation to consumers on display devices in the retail establishment. At a block 505, the correlation module receives UUIs from one or more mobile devices that are in a correlation zone. Such UUIs are received from a correlation zone manager 130 that is associated with the correction zone. At a block 510, the correlation module receives one or more marker IDs from markers that are present in a detection region or regions that overlap (i.e., cover some or all of the same area) with the correlation zone. At a decision block 515, the correlation module determines whether only a single UUI and marker ID have been received for the analyzed correlation zone. If only a single UUI and marker ID have been received, the correlation module presumes that the corresponding mobile device and marker are associated with the same consumer. As a result, at a block 520, the correlation module creates a temporary association between the UUI and the marker ID. The association is temporary because the marker ID is only associated with the UUI for the duration of the corresponding mobile device's visit to the retail establishment. If the consumer were to leave the retail establishment and return on a subsequent visit, the marker that would be associated with the consumer on the next visit would most likely be different as the consumer selects a different shopping cart, basket, bag, etc. to carry their goods.

In contrast, if multiple UUIs or marker IDs are detected at decision block 515, processing continues at a block 525. At block 525, the correlation module 215 selects one of the detected UUIs to process. At a decision block 530, the correlation module determines whether there is a stored list of potential marker IDs that are associated with the selected UUI. If it is the first time that a particular UUI has been checked, there would be no stored list of potential marker IDs. If no list of potential marker IDs exists for a particular UUI, processing continues to a block 535 where all detected marker IDs are stored as a list of potential markers for the selected UUI. When multiple potential marker IDs exist for a UUI, the correlation module is unable to uniquely determine which marker ID should be associated with the UUI. As a result, the correlation module stores all of the marker IDs as possible markers for the UUI. For example, a consumer with a mobile device may find themselves surrounded by three shopping carts, each of which contains a marker with a different marker ID. Under these circumstances, the correlation module is unable to determine which shopping cart should be associated with the consumer. The correlation module therefore stores the marker ID associated with each of the three shopping carts, since the consumer is likely associated with at least one of the shopping carts. Each of the shopping carts is merely considered as a potential match, however, until the correlation system is able to eliminate two of the shopping carts as possibilities. After storing all detected marker IDs as a list of potential markers, processing continues to a decision block 540 where the correlation module determines whether there are any remaining UUIs to process. If there are remaining UUIs, processing returns to block 525 where the correction module selects another detected UUI to process. Otherwise processing halts.

Returning to decision block 530, if the processed UUI has a list of stored potential markers that are associated with it, processing continues to a block 545. At block 545, the correlation module compares the detected marker IDs with the list of stored potential marker IDs. At a decision block 550, the correlation module determines whether there is a single marker ID that is contained in both the detected marker IDs and potential marker IDs. If a single marker ID is present in both the detected marker IDs and the list of potential maker IDs, then at block 560 the correlation module presumes that the corresponding mobile device and marker are associated with the same consumer and creates a temporary association between the UUI and the marker ID. The association is temporary because the marker ID is only associated with the UUI for the duration of the corresponding mobile device's visit to the retail establishment. Processing then continues to decision block 540 to determine whether any UUIs remain to be processed.

If at decision block 550 multiple pairs of the same marker IDs are still contained in both the detected marker IDs and list of potential marker IDs, the correlation module is unable to make a unique assignment between mobile device and marker. As a result, at a block 555, the correlation module deletes those marker IDs that are in the list of potential marker IDs but which aren't in the detected marker IDs. Deleting marker IDs that aren't found in both the detected marker IDs and list of potential marker IDs narrows, but doesn't completely remove, the ambiguities that the correlation module must resolve before associating a marker with a mobile device. For example, if three marker IDs are currently detected at decision block 550, and those three marker IDs as well as two additional marker IDs are contained in the list of potential marker IDs, the correlation module may delete the two additional marker IDs. The two additional marker IDs may be removed from the list since they are not in the set of potential matching marker IDs that are currently detected in the correlation zone. The correlation module cannot, however, resolve the correlation ambiguity that remains between the remaining three marker IDs, so the remaining three marker IDSs are maintained in the list until the next time that the mobile device is detected in a correlation zone.

The process 500 depicted in FIG. 5 is intended to quickly resolve ambiguities and allow markers to be assigned to mobile devices. Even if the correlation module is not able to resolve the ambiguity the first time that a consumer passes through a correlation zone 135, it is likely that the ambiguity will be resolved in fairly short order as the consumer passes through a second or subsequent correlation zone. Such subsequent correlation zone may be, of course, the same as the first correlation zone but at a later time when different markers and mobile devices are present in the zone.

Once a marker is assigned to a mobile device, the correlation system 200 is able to provide information about the mobile device consumer to the advertising system 225 or to other systems in the retail environment. The provided information may be used by the advertising or other system to improve the shopping experience of the consumer. For example, the correlation system 200 may provide information about past purchases of the consumer to the advertising system 225 so that the advertising system can better select and provide meaningful advertising content to the consumer. As another example, the correlation system 200 may provide financial information to the check out systems of the retail establishment to allow the consumer to quickly pay for items that are in a marker-identified shopping cart, basket, or other container that is used to carry products.

In addition to providing information about the consumer, the correlation system 200 is also to receive information from the advertising system 225 or other systems used in the retail environment. For example, the advertising system 225 may provide information to the correlation system 200 about advertisements that were presented to a consumer during a shopping session. Such information may be stored by the correlation system and provided to advertising systems at other retail establishments to allow those advertising systems to better target advertising content to the consumer. As another example, the check-out systems at the retail establishment may provide information about the products purchased by the consumer during a shopping session so that the aggregate purchase information across all merchants is maintained by the correlation system. The aggregate purchase information of a consumer may not be shared across merchants, but may be used to allow better targeting of advertising content to a consumer when the consumer enters any retail establishment.

Once a consumer finishes a shopping session, the correlation system 200 deletes the association of the marker and the mobile device if the association is only a temporary association (e.g., if the maker and mobile device are only associated for a single consumer visit). The correlation system 200 may delete the association when it detects or receives an indication that the consumer has paid for products at the retail establishment. The correlation system 200 may also delete the association if the marker has not moved for a threshold period (e.g., if the marker has been stationary for more than ten minutes), which may indicate that the cart, basket, bag, etc., to which the marker is attached has been abandoned by the consumer. Once the correlation system 200 determines that the mobile device is no longer near the marker, the association between the two is removed.

In some embodiments, it will be appreciated that the correlation system 200 may use a list of potential marker IDs to provide initial targeting even though some ambiguity exists as to the actual one-to-one correspondence between markers and mobile devices. For example, the correlation module 215 might detect the presence of three UUIs and three marker IDs in the same correlation zone. Even though the correlation module is unable to determine a unique association between the corresponding markers and mobile devices, the correlation module can use aggregate information from all three mobile devices to being targeting advertising content to all display devices near all three markers. For example, the correlation module may assess common characteristics (e.g., age, gender, similarity of products previously purchased) across the consumers associated with all three mobile devices, and may provide the common characteristics to the advertising system 225 so that the advertising system may select advertising content based on the common characteristics. The advertising system causes the advertising content to be presented to the consumers associated with all three devices. The presentation of advertising content to all three consumers in this fashion is as an approximation until a one-to-one correspondence between mobile devices and markers is determined.

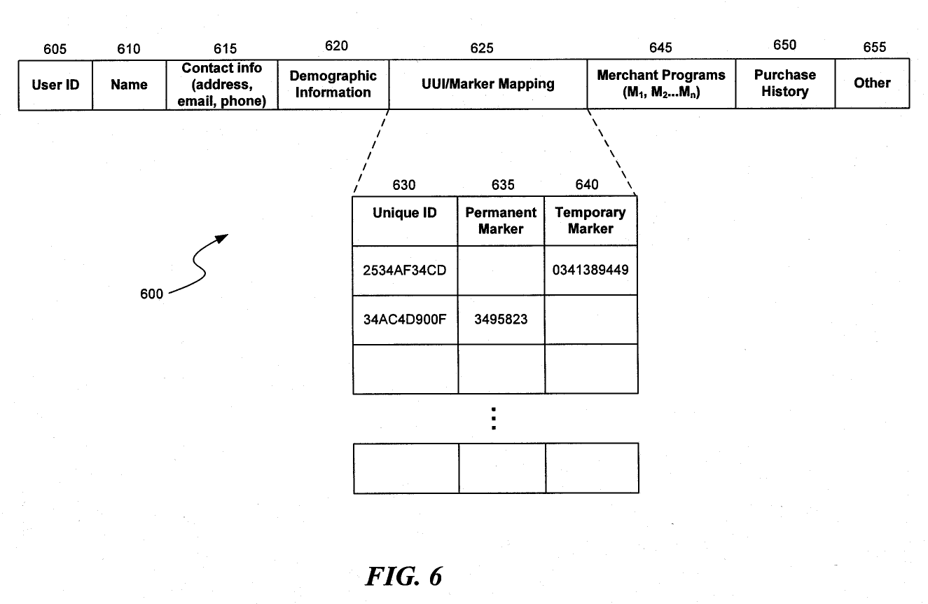

FIG. 6 is a representative consumer account 600 for storing data associated with the consumer. The first four segments in the account 600 reflect personal information about the consumer. A “user ID” field 605 contains a unique identifier that is assigned by the correlation system 200 to the consumer for identification purposes. A “name” field contains the name of the consumer. A “contact info” field 615 contains contact information for the consumer, such as the consumer's email address, phone number, mailing address, etc. And a “demographic information” field 620 contains demographic information that characterizes the consumer, such as age, gender, nationality, income, etc. The demographic information may be provided by the consumer during the registration process with the correlation system, or the demographic information may be obtained from third-party sources or derived by analyzing the purchase behavior of the consumer.

The next segment in the consumer's account 600 reflects data used to track the correspondence between a consumer's mobile device and advertising system markers. A “UUI/Marker Mapping” segment 625 contains three fields: a “UUI” field 630, a “permanent marker” field 635, and a “temporary marker” field 640. The UUI field 630 contains the universally unique identifier that is received from a mobile device and which uniquely identifies the mobile device. The permanent marker field 635 contains the marker ID of a marker that is permanently or semi-permanently associated with the mobile device (i.e., the marker is attached to or associated with the mobile device in a manner that allows the same marker to be present across different shopping sessions at a retail establishment). The temporary marker field 640 contains the marker ID of a marker that is associated with the mobile device for a single shopping session (e.g., a marker on a cart that the consumer uses while visiting a retail establishment). While the permanent maker field is typically populated by the correlation system only once, the temporary marker field is constantly being updated by the correlation system.

The remaining segments in the consumer's account 600 allow the correlation system to track various information associated with the buying behavior of the consumer. A “merchant programs” segment 645 maintains a record of the merchant programs with which the consumer is associated. As previously noted, a consumer may associate one or more merchant loyalty programs, merchant payment programs (e.g., Amazon Payments, PayPal, etc.), merchant identity programs (e.g., Google ID, Live ID, Yahoo! ID, etc.), or other merchant programs with a particular mobile device. The merchant programs segment contains identifiers, such as a unique alpha-, numeric-, or alpha-numeric code, that is generated by a merchant for the consumer. The merchant programs segment may also contain a textual description or other reference to identify the source of the code (e.g., “Target@ frequent shopper program,” “Kroger® loyalty program”), as well as a password or other code necessary to access certain features of the merchant program. A “purchase history” segment 650 maintains a record of purchases that the consumer makes across all merchants. The purchase history may be accessed by, for example, the advertising system 225 to better target advertisements to the consumer.

An “other” segment 655 may be used by the correlation system to store other information associated with the consumer or the consumer's mobile device. For example, the correlation system may store information related to past mobile devices that were previously used by the consumer. The other segment 655 may also be used to maintain financial information about the consumer, such as credit and debit card information, bank account information, and other financial details that can be used by a merchant to complete a transaction. As yet another example, the other segment 655 may be used to store a record of advertising content that was presented to the consumer during the shopping session. The past advertising content may be used by the advertising system to better target future advertising content.

One advantage of storing multiple merchant programs in the consumer's account is that it greatly facilitates the ability of the consumer to sign-up for new merchant programs. The consumer's name, contact info, demographic information, etc., can be automatically provided to a new merchant during the registration process. The consumer may therefore be required to provide minimal, if any, new information during the registration. Another advantage of storing multiple merchant programs in the consumer's account is that it allows information gathered about a consumer to benefit all merchants that interact with that consumer. For example, a purchase at one merchant may result in a recommendation at a different merchant for a non-competing, but complementary, product or service.

Yet another advantage of storing multiple merchant programs in the consumer's account is that it allows activities associated with a consumer's online activities to be used by the advertising system to target advertising content in the bricks-and-mortar (offline) world. For example, if a consumer provides the correlation system with the consumer's Google ID, Live ID, or Yahoo! ID, and the corresponding merchant program is willing to share information with the correlation system about the consumer's interests, browsing behavior, purchases, or other actions, the correlation system can then provide such information to the advertising system to better target advertising content to the consumer. An example use case might be a consumer's review of certain recipes on a website. The correlation system may receive a record of such browsing behavior by the consumer and provide the record to the advertising system to allow the advertising system to better target the consumer (e.g., “We noticed that you just placed baking chocolate in your basket, would you be interested in a coupon for another ingredient from the chocolate cake recipe that you were reading about yesterday?”).

While the correlation system 200 and the advertising system 225 were described herein as separate systems, it will be appreciated that the functionality of the two systems may be merged into a single system. For example, the functionality of the correlation zone managers 130 may be merged with the functionality of the region managers 230. The separation into two systems was intended to merely facilitate the description of the disclosed technology.

From the foregoing, it will be appreciated that specific embodiments of the invention have been described herein for purposes of illustration, but that various modifications may be made without deviating from the spirit and scope of the invention. Those skilled in the art will appreciate that the depicted flow charts may be altered in a variety of ways. For example, the order of the steps may be rearranged, steps may be performed in parallel, steps may be omitted, or other steps may be included. While FIG. 6 depicts an account whose contents and organization are designed to make them more comprehensible by a human reader, those skilled in the art will appreciate that the actual data structure(s) used by the system to store this information may differ from the log shown, in that it, for example, may be organized in a different manner, may contain more or less information than shown, may be compressed and/or encrypted, and may be optimized in a variety of ways. Accordingly, the invention is not limited except as by the appended claims.

I/We claim:

1. A computer-implemented method of associating a mobile device with a marker used to deliver advertising content in a retail environment, the computer-implemented method comprising:
maintaining information characterizing a consumer having a mobile device;
receiving a universally unique identifier that is associated with the mobile device of the consumer, the universally unique identifier detected in a correlation zone of a retail establishment;
receiving one or more marker identifiers associated with each of one or more markers that is present in the correlation zone with the mobile device, the markers being used by an advertising system to deliver advertising content to a display device that is in proximity to the consumer;
associating one of the received marker identifiers with the universally unique identifier; and
providing at least some of the information characterizing the consumer to the advertising system to allow the advertising system to target the advertising content to the consumer based on the associated marker identifier.

2. The computer-implemented method of claim 1, wherein the information characterizing the consumer is selected from a group consisting of contact information, demographic information, financial information, merchant program information, and purchase history information.

3. The computer-implemented method of claim 1, wherein the associated marker identifier is associated with the universally unique identifier for the duration of a shopping session of the consumer.

4. The computer-implemented method of claim 1, wherein the associated marker identifier is associated with the universally unique identifier for the duration of more than one shopping sessions of the consumer.

5. The computer-implemented method of claim 1, wherein receiving one or more marker identifiers associated with one or more markers that are present in the correlation zone comprises receiving one or more marker identifiers from a detection zone that is at least partially overlapping with the correlation zone.

6. The computer-implemented method of claim 1, wherein the mobile device is a mobile phone.

7. The computer-implemented method of claim 1, wherein associating one of the received marker identifiers with the universally unique identifier comprises:
if only one marker is present in the correlation zone with the mobile device, associating the corresponding one received marker identifier with the universally unique identifier.

8. The computer-implemented method of claim 1, wherein associating one of the received marker identifiers with the universally unique identifier comprises:
if two or more markers are present in the correlation zone with the mobile device, storing the two or more corresponding marker identifiers as potential associated marker identifiers; and
associating one of the potential associated marker identifiers with the universally unique identifier when a unique correlation can be made between the one potential associated marker identifier and the universally unique identifier.

9. The computer-implemented method of claim 1, wherein the retail establishment is a grocery store, a drug store, or a clothing store.

10. A correlation system for associating a mobile device with a marker used to deliver advertising content in a retail environment, the correlation system comprising:
a data storage area storing information characterizing a consumer having a mobile device;
a communication module configured to:
receive a universally unique identifier that is associated with the mobile device of the consumer, the universally unique identifier detected in a correlation zone of a retail establishment; and
receive one or more marker identifiers associated with each of one or more markers that is present in the correlation zone with the mobile device, the markers being used by an advertising system to deliver advertising content to a display device that is in proximity to the consumer; and
a correlation module configured to associate one of the received marker identifiers with the universally unique identifier and provide at least some of the stored information characterizing the consumer to the advertising system to allow the advertising system to target the advertising content to the consumer based on the associated marker identifier.

11. The correlation system of claim 10, wherein the stored information characterizing the consumer is selected from a group consisting of contact information, demographic information, financial information, merchant program information, and purchase history information.

12. The correlation system of claim 10, wherein the correlation module associates the one marker identifier with the universally unique identifier for the duration of a shopping session of the consumer.

13. The correlation system of claim 10, wherein the correlation module associates the one marker identifier with the universally unique identifier for the duration of more than one shopping sessions of the consumer.

14. The correlation system of claim 10, wherein the communication module receives the one or more marker identifiers from the advertising system.

15. The correlation system of claim 14, wherein the one or more marker identifiers are received from markers in a detection zone that is at least partially overlapping with the correlation zone.

16. The correlation system of claim 10, wherein the mobile device is a mobile phone.

17. The correlation system of claim 10, wherein the correlation module associates one of the received marker identifiers with the universally unique identifier by:
if only one marker is present in the correlation zone with the mobile device, associating the corresponding one received marker identifier with the universally unique identifier.

18. The correlation system of claim 10, wherein the correlation module associates one of the received marker identifiers with the universally unique identifier by:
if two or more markers are present in the correlation zone with the mobile device, storing the two or more corresponding marker identifiers as potential associated marker identifiers; and
associating one of the potential associated marker identifiers with the universally unique identifier when a unique correlation can be made between the one potential associated marker identifier and the universally unique identifier.

19. The correlation system of claim 10, wherein the retail establishment is a grocery store.

20. A computer-implemented method of associating a plurality of merchant programs with a mobile device of a consumer, the computer-implemented method comprising:
receiving a universally unique identifier that is associated with a mobile device of a consumer;
storing the received universally unique identifier in a record associated with the consumer;
receiving information characterizing the consumer, wherein the received information includes actions by the consumer in two or more merchant programs in which the consumer participates;
storing the received information characterizing the consumer in the record associated with the consumer;
correlating the universally unique identifier associated with the mobile device with a marker identifier associated with a marker used by an advertising system to track the movement of consumers in a retail establishment; and
providing at least some of the stored information characterizing the consumer to the advertising system in order to target advertising content delivered by the advertising system in the retail establishment.

21. The computer-implemented method of claim 20, wherein the universally unique identifier is received from a correlation zone manager in the retail establishment.

22. The computer-implemented method of claim 20, wherein the universally unique identifier is received from an application on the mobile device.

23. The computer-implemented method of claim 20, wherein the received information characterizing the consumer further includes contact information, demographic information, or financial information.

24. The computer-implemented method of claim 20, wherein the two or more merchant programs are loyalty programs.

25. The computer-implemented method of claim 20, wherein correlating the universally unique identifier associated with the mobile device with a marker identifier associated with a marker used by an advertising system comprises:
receiving a marker identifier associated with a marker that is in proximity to the mobile device; and
associating the received marker identifier with the universally unique identifier.

26. The computer-implemented method of claim 20, wherein the provided information includes information about purchases made in a merchant program not associated with the retail establishment.

27. The computer-implemented method of claim 20, wherein the provided information includes information about browsing activity from a merchant program not associated with the retail establishment.

28. The computer-implemented method of claim 20, wherein the provided information includes information about advertising content presented in a merchant program not associated with the retail establishment.

29. The computer-implemented method of claim 20, wherein the associated marker identifier is correlated with the universally unique identifier for the duration of a shopping session of the consumer.

30. The computer-implemented method of claim 20, wherein the associated marker identifier is correlated with the universally unique identifier for the duration of more than one shopping sessions of the consumer.
